(19) United States
(12) Patent Application Publication
(10) Pub. No.: US 2023/0237600 A1
(43) Pub. Date: Jul. 27, 2023

(54) SYSTEM AND METHOD FOR PROVIDING A MARKETPLACE FOR CRYPTOGRAPHIC LENDING ASSET SWAP TRANSACTIONS

(71) Applicant: Celligence International LLC, Guaynabo, PR (US)

(72) Inventors: PAVAN AGARWAL, Arcadia, CA (US); GABRIEL ALBORS SANCHEZ, Arcadia, CA (US); JONATHAN ORTIZ RIVERA, Arcadia, CA (US); THOMAS SMITH, Arcadia, CA (US)

(73) Assignee: Celligence International LLC, Guaynabo, PR (US)

(21) Appl. No.: 18/100,959

(22) Filed: Jan. 24, 2023

Related U.S. Application Data
(60) Provisional application No. 63/302,521, filed on Jan. 24, 2022.

(51) Int. Cl. G06Q 50/16; G06Q 40/03

(52) U.S. Cl. CPC G06Q 50/167; G06Q 40/03; G06Q 2220/00

(57) ABSTRACT

Methods and processes can include disbursement and/or management and issuance of guaranteed preapprovals in real property transactions recorded as smart contracts in a distributed digital ledger system. In some embodiments, holders of guaranteed preapproval NFTs may be linked to real property purchase agreements also recorded as NFTs. Holders of the real property purchase agreement NFTs may swap with other holders of the guaranteed preapproval NFTs received form an approved lending entity.

### RELATED APPLICATIONS

This application claims the benefit of U.S. Provisional Application No. 63/302,521 filed on Jan. 24, 2022, the contents of which are incorporated herein by reference in its entirety.

### TECHNICAL FIELD

The present disclosure generally relates to distributed ledger computer systems. More particularly, the present disclosure relates to computer systems and processes for providing, administering, and/or managing agreements backed by guaranteed preapprovals using blockchain technology.

### BRIEF DESCRIPTION OF THE DRAWINGS

The technology disclosed herein, in accordance with one or more various embodiments, is described in detail with reference to the following figures. The drawings are provided for purposes of illustration only and merely depict typical or example embodiments of the disclosed technology. These drawings are provided to facilitate the reader's understanding of the disclosed technology and shall not be considered limiting of the breadth, scope, or applicability thereof. It should be noted that for clarity and ease of illustration these drawings are not necessarily made to scale.

FIG. 1 illustrates an example system for generating and swapping cryptographic digital lending assets, according to an implementation of the disclosure.

FIG. 2A illustrates a digital copy of a guaranteed preapproval issued to a buyer, according to an implementation of the disclosure.

FIG. 2B illustrates an example cryptographic guaranteed preapproval token, according to an implementation of the disclosure.

FIG. 2C illustrates an example cryptographic real property agreement token, according to an implementation of the disclosure.

FIGS. 3-4 illustrate examples of a system providing the swapping of the cryptographic digital lending assets, according to an implementation of the disclosure.

FIG. 5 illustrates a method for swapping cryptographic digital lending assets, according to an implementation of the disclosure.

FIG. 6 illustrates an example computing system that may be used in implementing various features of embodiments of the disclosed technology.

Described herein are systems and methods for generating and swapping cryptographic digital lending assets. The details of some example embodiments of the systems and methods of the present disclosure are set forth in the description below. Other features, objects, and advantages of the disclosure will be apparent to one of skill in the art upon examination of the following description, drawings, examples and claims. It is intended that all such additional systems, methods, features, and advantages be included within this description, be within the scope of the present disclosure, and be protected by the accompanying claims.

### DETAILED DESCRIPTION

In a seller's market, the demand for housing exceeds supply. With fewer homes available, bidding wars have become more common, and buyers are often forced to make sacrifices in terms of their acquisitions. Often, in an effort to ensure that nothing gets in the way of their purchase, buyers try to make their offers as enticing as possible. For example, making an “all-cash offer,” may be one way to secure the buy. However, not all the buyers have the cash. Moreover, “cash buyers” (i.e., buyers making an “all-cash” offer) can sometimes be overly difficult to transact with (as they are more reluctant to part with their cash) and, therefore, less attractive to the seller. Accordingly, some buyers that need to finance their purchase, will go the route of a “no financing (or mortgage) contingency” route, which effectively equates their mortgage offer as an “all-cash” offer. A “no financing contingency” offer waives financing contingencies (i.e., difficulties that buyer may experience in actually receiving the mortgage loan) and indicates to the seller that the buyer is serious and determined to close.

Most buyers that make an offer with “no financing contingency” do so on the basis of being preapproved by the lender. However, being preapproved for a mortgage may not guarantee that the buyer will obtain the funds needed to purchase a house. Moreover, waiving a financing (or mortgage) contingency can be risky, as it prevents buyers from backing out of the agreement to buy, e.g., in the event their financing falls through. In other words, without this contingency, buyers are still obligated to surrender their earnest money or pay the full purchase price of the home regardless of whether they have the funds.

To help buyers looking to make a “no financing contingency” offer, some lenders have been issuing not just a preapproval but a “guaranteed” preapproval. By issuing a “guaranteed” preapproval, a lender not only provides the preapproval, but essentially backs the mortgage as if the transaction went through. This kind of preapproval removes some of the buyer's risks for the, i.e., not qualifying for the loan despite being preapproved, as discussed above. This reduction in the buyer's risks serves to increases the seller's confidence that the transaction will go through, i.e., minimizing the risk of the buyer not being able to pay the purchase price despite being preapproved. Accordingly, the seller is more willing to accept an offer from the buyer that has both (1) waived a financing contingency, and (2) secured a guaranteed preapproval from a lender. This type of offer is known as “TRUApproval” offer from Sun West Mortgage Company, Inc.). As alluded to above, because the seller's risks have been practically reduced to zero, the seller will be preferential to this type of offer mor than any other offer, including an “all-cash” one.

After the guaranteed preapproval offer has been accepted by the seller, the closing often takes place within sixty or so days. In the current volatile real property market, the market conditions change rapidly, and it may be beneficial for the buyer to exploit the changing market during the pre-closing period (i.e., the period commencing as of the date of the buy-sell agreement and ending on the closing date).

One way to exploit the market is to allow the buyer to “trade” the guaranteed preapproval offer with another buyer at a profit. For example, a buyer may “sell” their accepted offer (i.e., accepted by the seller) to buy a property for $100,000 to another buyer for $150,000. During the closing, the second buyer will close on the $100,000 property and the original buyer will receive $50,000 in profit. In some embodiments, the buyer acquiring the accepted offer may have to be in possession of a “guaranteed preapproval” from a lender for $150,000. In some embodiments, the guaranteed preapproval may be based on financial qualifications and other characteristics of the buyer.

Traditionally, trading accepted offers is not possible because offers to buy are non-transferrable from one buyer to another. However, by converting the guaranteed preapproval offer to a cryptographic digital asset, results in the buyer using the cryptographic digital asset for transacting on a secure decentralized ledger that is distributed throughout its open network. For example, this decentralized ledger, known as the blockchain, allows participants in the network to transact without the need for a trusted third party, such as a bank. This electronic ledger resides on the blockchain and, as such, may be immutable and accessible at any node on the blockchain network.

The blockchain is generated and distributed by any distributed computing platform and operating system. One such example is the Ethereum platform, one of several cryptocurrency platforms that provide for the formation and execution of smart contracts and for running blockchain applications. A digital asset is the catch-all term for assets that exist digitally. The term covers a wide variety of assets, including cryptocurrencies, utility tokens, security tokens, digital stocks, and digital collectables. All cryptocurrencies are digital assets, while not all digital assets are cryptocurrencies. The two most common blockchain-based digital assets are cryptocurrencies and tokens.

In accordance with various embodiments, a system for enabling real property agreements that are transacted via a distributed ledger network is disclosed. On the distributed ledger system, smart contracts can be created and recorded to memorialize these real property agreements, record buyer and seller information, record owner information, record contingency information (e.g., financing contingency), record property information including purchase price, lender and the type of preapproval (e.g., guaranteed preapproval), and/or record closing or satisfaction of the agreement.

As described earlier, prior to entering into a real property agreement, a buyer must secure a guaranteed preapproval from a lender. In one embodiment, a lending entity may approve prospective borrowers based on creditworthiness or other factors as may be desirable. In other embodiments, borrowers are selected according to specified criteria. For example, the lending entity may use criteria for selecting borrowers similar to criteria currently in use for traditional financing operations. Similarly, the lending entity may consider loan-to-value ratio, debt-to-income ratio, credit score, or other factors relevant to the loan risk. In other words, potential loans may be analyzed and considered in a manner similar to that of a conventional lending operation. Once the lender approves the borrower's request, the lender issues the guaranteed approval as a cryptographic token or, simply, a crypto token. While crypto tokens, like cryptocurrency, can hold value and be exchanged, they can also be designed to represent physical assets or more traditional digital assets, or a certain utility or service. For instance, there are crypto tokens that represent tangible assets such as real estate and art, as well as intangible assets such as processing power or data storage space. For example, a non-fungible token (NFT) is a cryptocurrency token that is indivisible and unique. One NFT cannot be interchanged with another NFT, and the whole cannot be broken down into smaller parts and used. Within the context of blockchain technology, a cryptographic token (a crypto token or token) generally refers to a unit of value for a programmable asset that is managed by a smart contract and an underlying distributed ledger. Tokens are the primary means of transferring and storing value on a blockchain network—most often Ethereum. Tokens can also be designed to be either fungible or non-fungible (non-fungible tokens are known as “NFTs”), depending on a network's specific needs.

Cryptocurrency and tokens (both unique subclasses of digital assets) utilize cryptography, an advanced encryption technique that assures the authenticity of crypto assets by eradicating the possibility of counterfeiting or double-spending. The biggest differentiation between the two is that cryptocurrencies have their own blockchains, whereas crypto tokens are built on an existing blockchain.

The guaranteed preapproval issued by the lender as an NFT will be linked to the borrower. Furthermore, the smart contract (or a smart subcontract, and or any combination of these components) used to manage the guaranteed preapproval token may be initialized to memorialize the details, rules, conditions, and other such information associated with the issuance of the guaranteed preapproval. For example, the conditions under which the lender has the ability to revoke the guaranteed preapproval may be embedded into the smart contract. In various embodiments, the guaranteed preapproval can be tracked by a digital wallet. Additionally, all guaranteed preapprovals issued by a particular lender will have the same conditions. Thus, by virtue of all guaranteed preapprovals having the same conditions allows for them to be exchangeable, as will be described in detail herein.

Next, the buyer may use the guaranteed preapproval token to make offers to purchase real property from sellers. Upon a seller accepting buyer's offer, the buyer may enter into a real property agreement with the seller to buy the property backed by the lender (i.e., by virtue of the guaranteed preapproval). Again, the smart contract record associated with the token will reflect the details of the real property agreement between buyer and seller, e.g., the agreed-upon purchase price, the property information, and so on. Additionally, digital wallet identification(s) for lender, borrower (i.e., buyer), and/or seller may be included in the smart agreement. Notably, the execution of the buy-sell agreement may cause a generation of a separate digital representation of the agreement, i.e., an agreement token. This agreement token may be linked with the buyer and buyer's assigned guaranteed preapproval token.

This representative method includes, in any order and in any combination with any of the above or below disclosed features and options: receiving a transaction confirmation indicative of an accepted offer or an agreement to purchase real property by a buyer from a seller based on a guaranteed preapproval from a lender, determining a unique buyer identification code, receiving a validated guaranteed preapproval token associated with the buyer identification code, determining a unique guaranteed preapproval token identification code, generating an agreement token (or a cryptographic digital asset associated with the agreement), the agreement token including a unique agreement identification code (e.g., a key and cryptographic token), linking the cryptographic digital lending asset with the unique buyer identification code and the guaranteed preapproval token identification code, and transmitting to a distributed blockchain ledger (e.g., Bitcoin, Ethereum, Litecoin, etc.), the unique agreement identification code linked with the unique buyer code, and guaranteed preapproval token identification code for recordation on a transaction block.

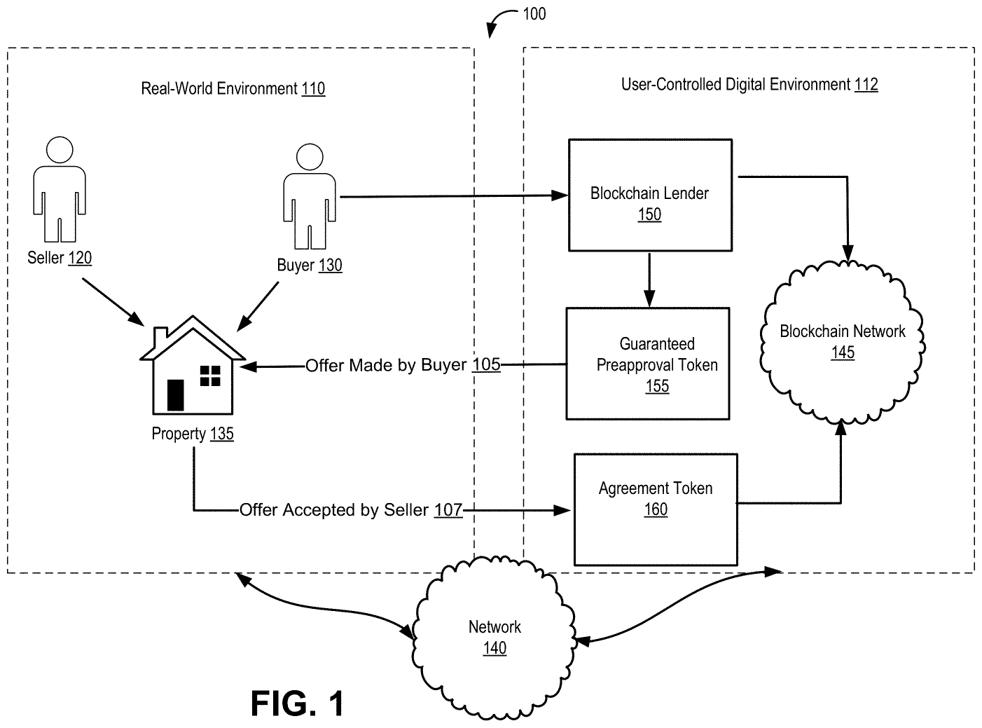

FIG. 1 illustrates exemplary system for generating and swapping cryptographic digital lending assets 100, in accordance with the embodiments disclosed herein. This system 100 includes an example real-world environment 110 and an example user-controlled digital environment 112 (e.g., Metaverse) in communication with a network 140.

In some embodiments, one or more computing systems are connected by one or more communications channels, such as, but not limited to: any general network, communications network, or general network/communications network system; a cellular network; a wireless network; a combination of different network types; a public network; a private network; a satellite network; a plain old telephone service (“POTS”) network, a cable network, or any other network capable of allowing communication between two or more computing systems, as discussed herein, and/or available or known at the time of filing, and/or as developed after the time of filing.

Network 140 includes, but is not limited to, any network or network system such as, but not limited to, a peer-to-peer network, a hybrid peer-to-peer network, a Local Area Network (“LAN”), a Wide Area Network (“WAN”), a public network, such as the Internet, a private network, a cellular network, a POTS network; any general network, communications network, or general network/communications network system; a wireless network; a wired network; a wireless and wired combination network; a satellite network; a cable network; a Virtual Private Network (“VPN”), a Mesh Network (or other many-to-many system); a cryptographic Directed Acyclic Graph (“crypto DAG”); any combination of different network types; or any other system capable of allowing communication between two or more computing systems, whether available or known at the time of filing or as later developed. Some common embodiments may typically comprise an “Internet Protocol” address system and a distributed ledger technology system using cryptographic addresses as end points, but the scope of the present disclosure is not restricted to such. A person of ordinary skill in the art having the benefit of the present disclosure would understand that an address system can be used on multiple network types; for example, Ethereum's DLT technology running Ropstein, Mainnet, Casper, Kovan, Rinkeby, Goerli and Rinkeby networks.

In some embodiments, system 100 may include a real-world environment 110 including a seller 120 offering for sale a real property 135 and a buyer 130 interested in purchasing that property 135. Further, the system 100 may include a user-controlled digital environment 112, including a blockchain lender 150 that issues a guaranteed preapproval to buyer 130 (i.e., a borrower) which is assigned a cryptographic token 155. Buyer 130 enters into an agreement with seller 120 to purchase property 135 on the basis of the assigned token. An agreement token 160 is generated and linked to buyer 130 and the guaranteed preapproval token 155 for the agreement.

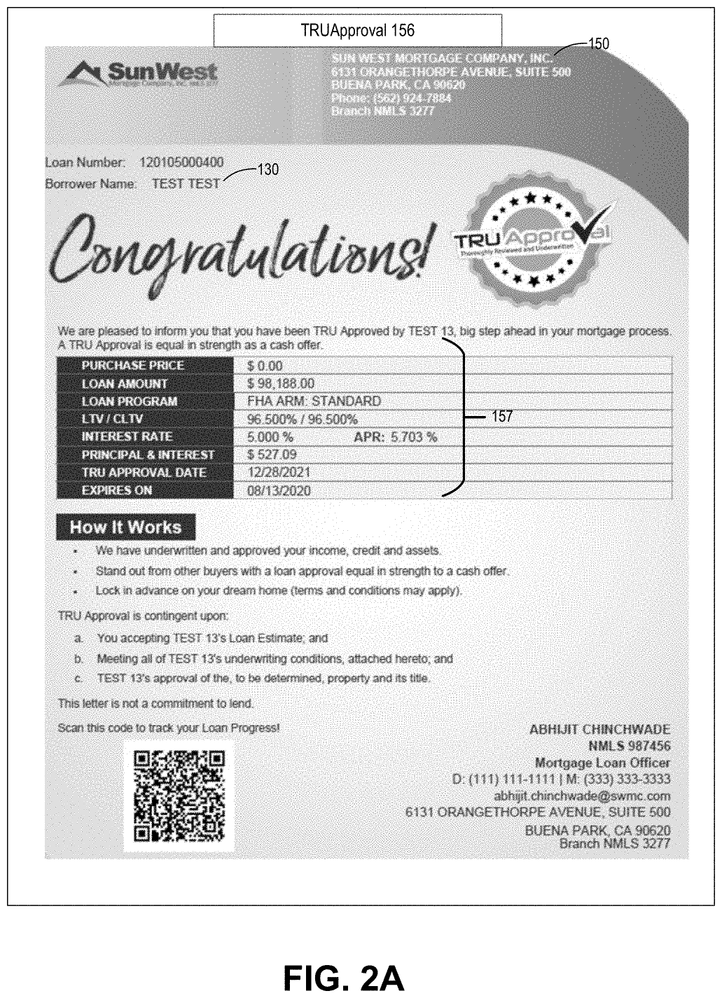

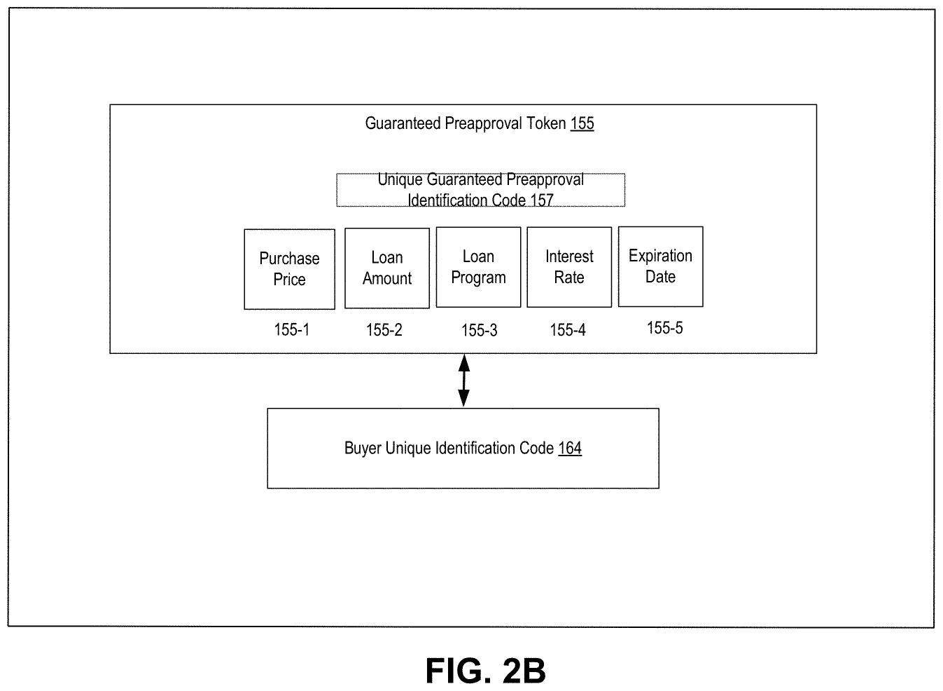

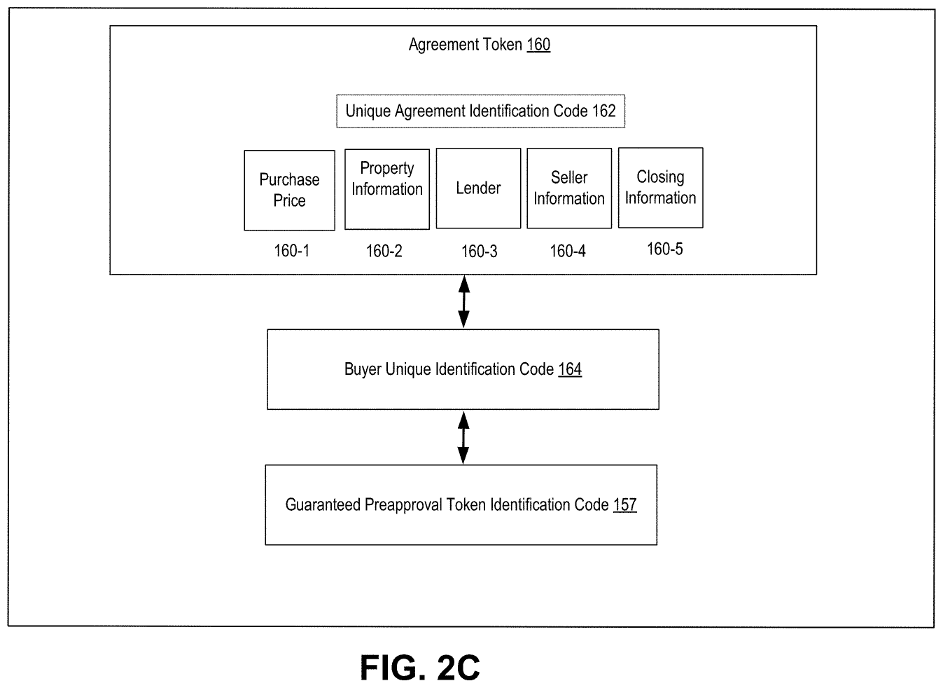

In some embodiments, both the guaranteed preapproval by the blockchain lender and the real property agreement between buyer and seller may be signed and prepared in document format. For example, as illustrated in FIG. 2A, a guaranteed preapproval or TRUApproval 156 may be issued by lender 150, in this case Sun West Mortgage Company, Inc., to buyer 130 (i.e., borrower). The TRUApproval 156 may include loan information 157 (e.g., purchase price, loan amount, loan program, ITV/CLTV, interest rate, principal and interest, date of issuance, and expiration date, and/or other such similar information). As alluded to above, the TruApproval 156 issued by lender 150 to buyer 130 and is based on credit and income characteristics of the buyer 130 as determined by lender 150 at the time of issuance.

The issued guaranteed preapproval and the executed real property agreement (illustrated in FIG. 1) may be digital scans of paper documents that were hand-signed before scanning and converting to a digital file format such as Portable Document Format (“PDF”), Tagged Image File Format (“TIFF”), and/or other file formats as discussed herein, and/or as known in the art at the time of filing, and/or as developed after the time of filing. In another embodiment, executed guaranteed preapproval and real property agreement may exist only as digital files, which are signed digitally before uploading to a third-party database. In various embodiments, the guaranteed preapproval and the real property agreement can be any hard copy and/or digital copy of a document or agreement relating to the preapproval issued by the lender.

In some embodiments, the guaranteed preapproval and the real property agreement are obtained as electronic data via, as illustrative examples, e-mail or the Internet. In other embodiments, the guaranteed preapproval and the real property agreement can be any electronic form of document, including a document generated from a paper document or a document that originated in a digital form. An electronic form of the guaranteed preapproval and the real property agreement can include, but is not limited to, PDF file with or without embedded text, an image file depicting the guaranteed preapproval and the real property agreement, a word-processing document file, or any other electronic file, as discussed herein, and/or as known in the art at the time of filing, and/or as developed after the time of filing.

The guaranteed preapproval NFT may be a cryptographic digital asset and may refer to any computer-generated virtual object, including digital agreement, that may have a unique, non-fungible tokenized code (“token”) registered on and validated by a blockchain platform or otherwise registered in an immutable database. For example, as illustrated in FIG. 2B, guaranteed preapproval token 155 (illustrated in FIG. 1) may refer to the electronic guaranteed preapproval 156 issued by lender 150 to buyer 130 (illustrated in FIG. 2A). The guaranteed preapproval token 155 include various attributes such as purchase price 155-1, loan amount 155-2, loan program 155-3, interest rate 155-4, expiration date 155-5, and/or other similar attributes. Because the guaranteed preapproval is issued to the buyer based on their financial qualifications and other characteristics of the buyer (FICO score, loan/debt ratio, assets, and/or such similar qualifying criteria) and the terms of the lender's commitment (qualifying amount, max interest rate, etc.), the guaranteed preapproval token 155 is valid as a funding guarantee so long as the buyer abides by the terms and conditions of the smart contract, i.e., the attributes 155-1-155-5. The guaranteed preapproval token 155 may be associated with a unique guaranteed preapproval identification code 157 and may be linked to the unique buyer identification code 164.

Referring back to FIG. 1, once buyer 130 is assigned the guaranteed preapproval token 155 (i.e., by linking the guaranteed preapproval token 155 to the unique buyer identification code 164), buyer 130 can make an offer (indicated in a transaction 105) to buy property 135 from seller 120. In some embodiments the buyer 130 may make the offer in a user-controlled digital environment 112 (e.g., Metaverse) or such similar environments.

Once the seller 120 accepts buyer's offer (indicated in a transaction 107) backed by guaranteed preapproval token 155, a real property agreement between the buyer 130 and seller 120 is formed. As alluded, to above, the real property agreement can be converted to a non-fungible token (“NFT”) managed a smart contract or smart subcontract and recorded in the blockchain ledger. Additionally, the real property agreement can be tracked by wallet, financial locker, and/or similar mechanism.

The closing of the real property purchase (i.e., as contemplated in the real property agreement) may occur on the closing date provided in the smart contract of associated real property agreement token. The closing event may be recorded in the blockchain ledger to, thereby, reflect the consummation of the transaction.

For example, as illustrated in FIG. 2C, real property agreement token 160 may include various attributes such as purchase price 160-1, property information 160-2, lender information 160-3, seller information 160-4, closing information 160-5, and/or other similar attributes. The agreement token 160 may be associated with a unique agreement identification code 162 and may be linked to the unique buyer identification code 164 and the guaranteed preapproval NFT 155 (illustrated in FIG. 2A) by referencing its unique identification code 157.

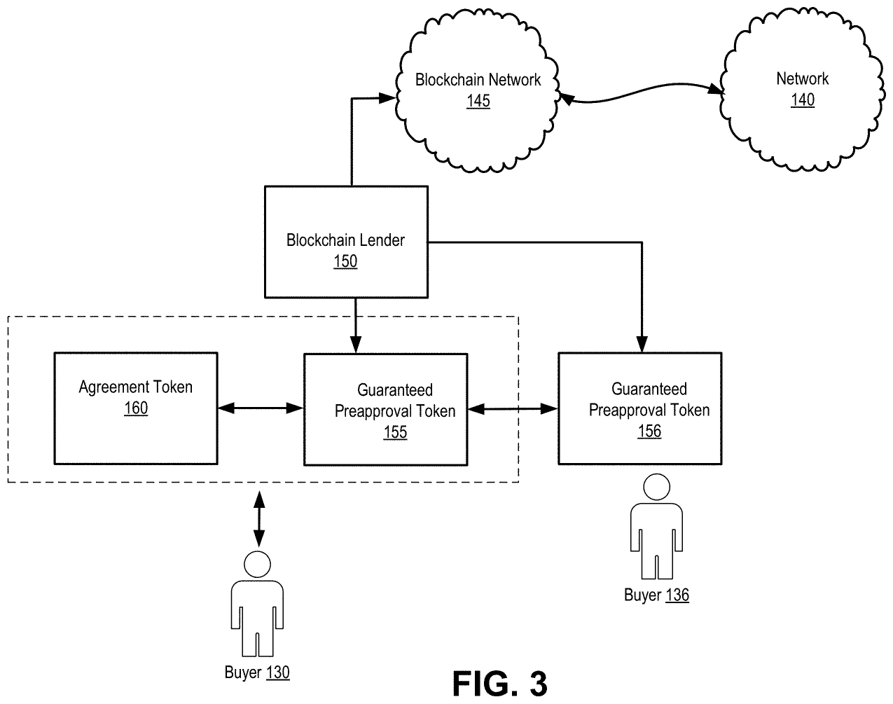

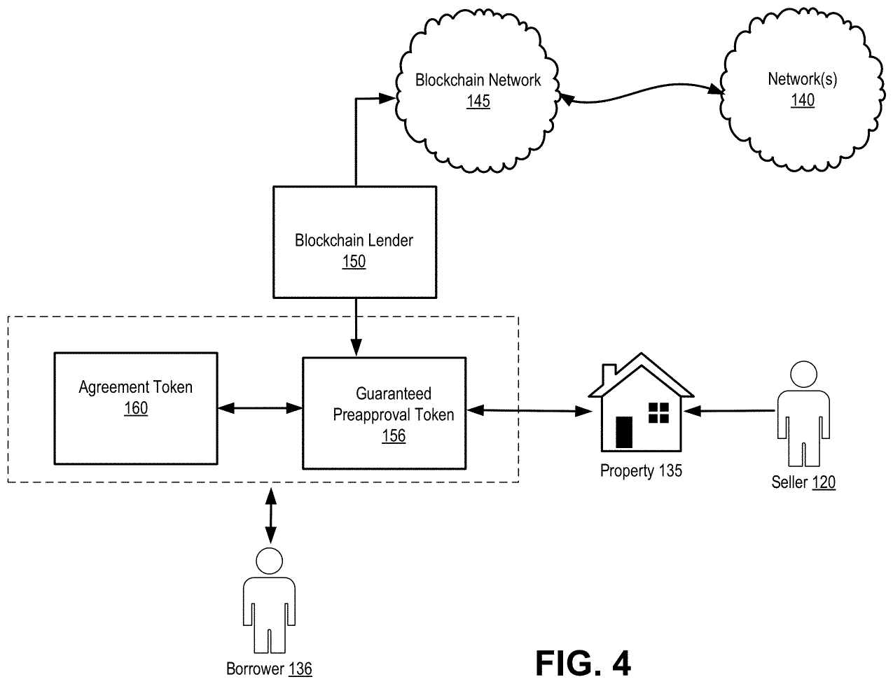

Referring back to FIG. 1, buyer 130, who is effectively the owner of the agreement token 160, may be able to swap the guaranteed preapproval token 155 linked to the agreement token 160 with another comparable preapproval token. For example, as illustrated in FIG. 3A, another buyer, buyer 136, may also obtain a guaranteed preapproval from blockchain lender 150. Upon buyer 136 receiving the guaranteed preapproval from lender 150, the guaranteed preapproval is assigned a cryptographic token 156.

As alluded to above in reference to FIG. 1, buyer 130 may swap the guaranteed preapproval token 155 linked to the real property agreement token 160 with guaranteed preapproval token 156 assigned to buyer 136. In essence buyer 130 is transferring his interest in the purchase of property 135 (illustrated in FIG. 1) to buyer 136 by swapping out guaranteed preapproval token 155 with token 156. The “swap” would be another ledger entry on the block chain.

For example, as illustrated in FIG. 3B, upon completing the swap, buyer 136 may act on the agreement to buy property 135 as previously agreed between seller 120 and buyer 130. By virtue of swapping the guaranteed preapproval, as described above, buyer 130 is able to capitalize on the fluctuations of the real property market during the pre-closing period. Once the transaction between the buyer 136 and seller 120 closes, that occurrence can be recorded in the blockchain ledger.

Of course, buyer 130 would only be incentivized to make the swap at a financial gain, i.e., if buyer 136 would pay more than what buyer 130 agreed to pay. By virtue of linking the guaranteed preapproval token to the real property agreement in a distributed ledger, initial buyer 130 is able to ask a higher preapproval amount and collect the difference during the swap. For example, in conventional real property transaction, there is an earnest money deposit requirement that is usually held by the listing realtor. With a blockchain-based transaction, as described above, there are two possibilities of recording that deposit. First, the cash deposit may be kept with the realtor, which is recorded as part of the real property agreement smart contract linked to buyer 130 or, alternatively, the cash deposit can be kept with the issuer of guaranteed preapproval (i.e., the lender 150).

When the buyer 130 transfers their interest in the real property agreement to buyer 136, buyer 136 is able to see (via the distributed ledger) exactly how much earnest money buyer 130 deposited with the listing agent or relator. Thus, buyer 136 is able to provide that amount to buyer 130 upon receipt of the real property agreement NFT from buyer 130.

However, by depositing the earnest money deposit with the realtor creates a timing problem as well as a problem of good funds where one of the buyers is potentially exposed. Rather than making the deposit with the realtor, buyer 136 deposits the money with the issuer of guaranteed preapproval (i.e., the lender 150). That way, the deposit is held by the trusted party and becomes a data point of guaranteed preapproval token 156 linked to buyer 136. Additionally, by using the lender as the party for the earnest deposit, the lender is able to transfer the deposit and the earnings from the transaction to the original buyer. For example, once buyer 130 transfers his interest in the real property agreement to buyer 136, the lender can move the money from buyer's 136 account to buyer's 130 account (including the deposit and the earnings). This transfer will be recorded as a transaction in the public ledger as well.

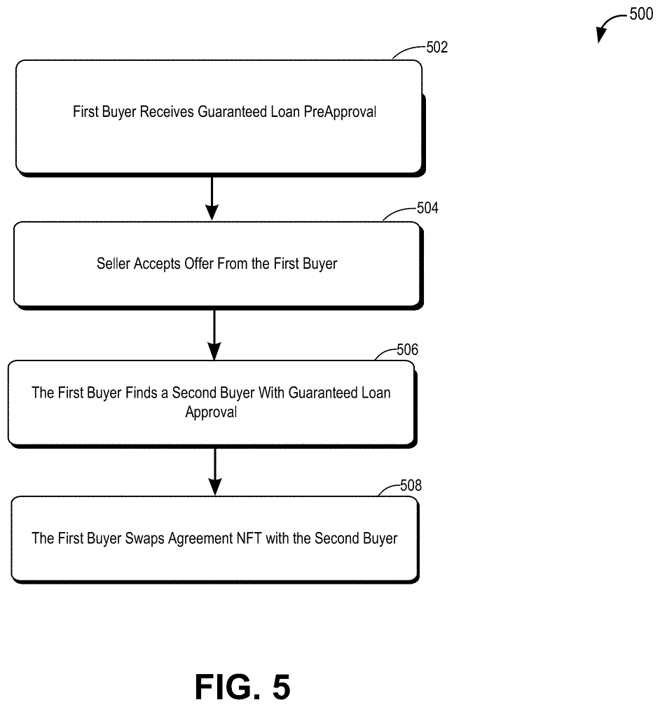

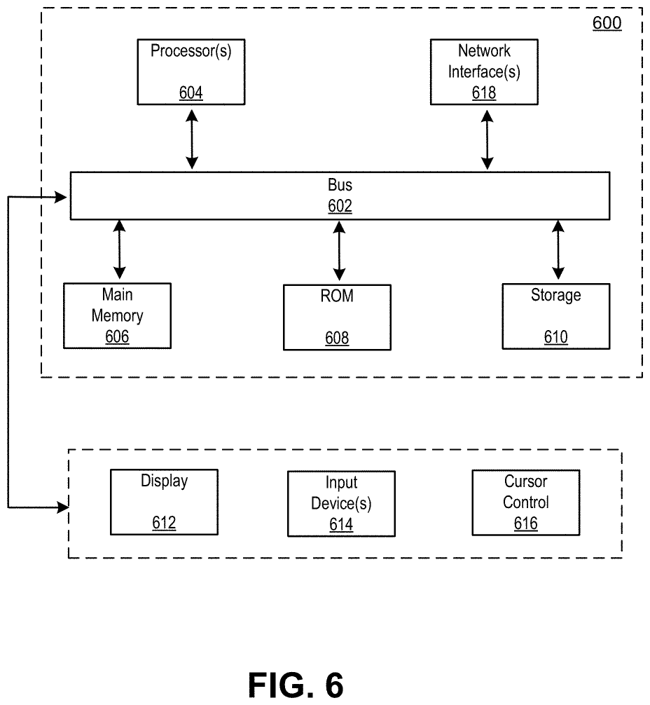

As illustrated in FIG. 5, in step 502, a buyer may receive a guaranteed loan preapproval from a blockchain lender in a user-controlled digital environment in connection with offering to purchase a real-state property from a seller. In step 504, a seller may accept buyer's offer that includes a guaranteed preapproval. In step 506, original buyer may find another buyer that is interested in purchasing the property. This second buyer must have their own guaranteed loan preapproval from a blockchain lender. In some embodiments, this preapproval may be for a higher amount than the asking prices. In step 508, the original buyer may swap the guaranteed preapproval token with that of the second buyer.

Where components or modules of the application are implemented in whole or in part using software, in one embodiment, these software elements can be implemented to operate with a computing or processing module capable of carrying out the functionality described with respect thereto. One such example computing module is shown in FIG. 6. Various embodiments are described in terms of this example-computing module 600. After reading this description, it will become apparent to a person skilled in the relevant art how to implement the application using other computing modules or architectures.

Referring now to FIG. 6, computing module 600 may represent, for example, computing or processing capabilities found within desktop, laptop, notebook, and tablet computers; hand-held computing devices (tablets, PDA's, smart phones, cell phones, palmtops, etc.); mainframes, supercomputers, workstations or servers; or any other type of special-purpose or general-purpose computing devices as may be desirable or appropriate for a given application or environment. Computing module 600 might also represent computing capabilities embedded within or otherwise available to a given device. For example, a computing module might be found in other electronic devices such as, for example, digital cameras, navigation systems, cellular telephones, portable computing devices, modems, routers, WAPs, terminals and other electronic devices that might include some form of processing capability.

Computing module 600 might include, for example, one or more processors, controllers, control modules, or other processing devices, such as a processor 604. Processor 604 might be implemented using a general-purpose or special-purpose processing engine such as, for example, a microprocessor, controller, or other control logic. In the illustrated example, processor 604 is connected to a bus 602, although any communication medium can be used to facilitate interaction with other components of computing module 600 or to communicate externally. The bus 602 may also be connected to other components such as a display 612, input devices 614, or cursor control 616 to help facilitate interaction and communications between the processor and/or other components of the computing module 600.

Computing module 600 might also include one or more memory modules, simply referred to herein as main memory 606. For example, preferably random-access memory (RAM) or other dynamic memory might be used for storing information and instructions to be executed by processor 604. Main memory 606 might also be used for storing temporary variables or other intermediate information during execution of instructions to be executed by processor 604. Computing module 600 might likewise include a read only memory (“ROM”) 608 or other static storage device 610 coupled to bus 602 for storing static information and instructions for processor 604.

Computing module 600 might also include one or more various forms of information storage devices 610, which might include, for example, a media drive and a storage unit interface. The media drive might include a drive or other mechanism to support fixed or removable storage media. For example, a hard disk drive, a floppy disk drive, a magnetic tape drive, an optical disk drive, a CD or DVD drive (R or RW), or other removable or fixed media drive might be provided. Accordingly, storage media might include, for example, a hard disk, a floppy disk, magnetic tape, cartridge, optical disk, a CD or DVD, or other fixed or removable medium that is read by, written to or accessed by media drive. As these examples illustrate, the storage media can include a computer usable storage medium having stored therein computer software or data.

In alternative embodiments, information storage devices 610 might include other similar instrumentalities for allowing computer programs or other instructions or data to be loaded into computing module 600. Such instrumentalities might include, for example, a fixed or removable storage unit and a storage unit interface. Examples of such storage units and storage unit interfaces can include a program cartridge and cartridge interface, a removable memory (for example, a flash memory or other removable memory module) and memory slot, a PCMCIA slot and card, and other fixed or removable storage units and interfaces that allow software and data to be transferred from the storage unit to computing module 600.

Computing module 600 might also include a communications interface or network interface(s) 618. Communications or network interface(s) interface 618 might be used to allow software and data to be transferred between computing module 600 and external devices. Examples of communications interface or network interface(s) 618 might include a modem or softmodem, a network interface (such as an Ethernet, network interface card, WiMedia, IEEE 802.XX or other interface), a communications port (such as for example, a USB port, IR port, RS232 port Bluetooth® interface, or other port), or other communications interface. Software and data transferred via communications or network interface(s) 618 might typically be carried on signals, which can be electronic, electromagnetic (which includes optical) or other signals capable of being exchanged by a given communications interface. These signals might be provided to communications interface 618 via a channel. This channel might carry signals and might be implemented using a wired or wireless communication medium. Some examples of a channel might include a phone line, a cellular link, an RF link, an optical link, a network interface, a local or wide area network, and other wired or wireless communications channels.

In this document, the terms “computer program medium” and “computer usable medium” are used to generally refer to transitory or non-transitory media such as, for example, memory 606, ROM 608, and storage unit interface 610. These and other various forms of computer program media or computer usable media may be involved in carrying one or more sequences of one or more instructions to a processing device for execution. Such instructions embodied on the medium, are generally referred to as “computer program code” or a “computer program product” (which may be grouped in the form of computer programs or other groupings). When executed, such instructions might enable the computing module 600 to perform features or functions of the present application as discussed herein.

Various embodiments have been described with reference to specific exemplary features thereof. It will, however, be evident that various modifications and changes may be made thereto without departing from the broader spirit and scope of the various embodiments as set forth in the appended claims. The specification and figures are, accordingly, to be regarded in an illustrative rather than a restrictive sense.

Although described above in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the present application, whether or not such embodiments are described and whether or not such features are presented as being a part of a described embodiment. Thus, the breadth and scope of the present application should not be limited by any of the above-described exemplary embodiments.

Terms and phrases used in the present application, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. A computer-implemented method, the method comprising:
receiving, at a computing device, a request from a first buyer for a guaranteed mortgage preapproval terms by a lender;
in response to receiving the request, transmitting, by the computing device, a user interface to a computing device of the first buyer over at least one network to allow the first buyer to enter into the user interface data relevant to obtaining a guaranteed mortgage preapproval;
receiving the data, at the computing device over the at least one network from the computer of the first buyer via the user interface, in response to the first buyer entering in the data into the user interface, wherein the received data comprises borrower information including a home value, a down payment, and a mortgage term;
issuing the guaranteed mortgage preapproval to the first buyer, the guaranteed mortgage preapproval being represented by a cryptographic digital asset governed by a smart contract on a blockchain, wherein the cryptographic digital asset comprises a non-fungible token (NFT), and where the first buyer's guaranteed mortgage preapproval NFT storing first buyer information, property information, and seller information;
receiving, at the computing device, a request from the first buyer to prepare a contract record for storing contract data regarding terms of the contract in a blockchain or a database; and
linking the guaranteed mortgage preapproval NFT with the contract record for recordation in a new block in the blockchain distributed ledger.

2. The method of claim 1, wherein the request to prepare the contract record is associated with an offer to buy real property backed by the guaranteed mortgage preapproval, wherein the offer has been accepted by a seller of the real property.

3. The method of claim 2, wherein the contract is a smart contract that includes computer-readable instructions for verifying, authenticating and approving the property transfer-related event according to the terms and conditions of a buy-sell agreement of the offer.

4. The method of claim 3, further comprising:
receiving, at the computing device, a request from the first buyer to prepare a second contract record for storing contract data regarding terms of the second contract in a blockchain or a database, wherein the second contract record is associated with the offer to buy the real property backed by a guaranteed mortgage preapproval NFT of a second buyer.

5. The method of claim 4, further comprising linking the second buyer's guaranteed mortgage preapproval NFT with the contract record in a new block in the blockchain distributed ledger.

6. The method of claim 4, wherein the second buyer's guaranteed mortgage preapproval NFT is issued by the lender upon receiving, at the computing device, a request from the second buyer for the guaranteed mortgage preapproval terms by the lender; and is governed by the smart contract on the blockchain.

7. A non-transitory computer readable medium storing instructions that, when executed by a processor, performs a method, the method comprising:
receiving, at a computing device, a request from a first buyer for a guaranteed mortgage preapproval terms by a lender;
in response to receiving the request, transmitting, by the computing device, a user interface to a computing device of the first buyer over at least one network to allow the first buyer to enter into the user interface data relevant to obtaining a guaranteed mortgage preapproval;
receiving the data, at the computing device over the at least one network from the computer of the first buyer via the user interface, in response to the first buyer entering in the data into the user interface, wherein the received data comprises borrower information including a home value, a down payment, and a mortgage term;
issuing the guaranteed mortgage preapproval to the first buyer, the guaranteed mortgage preapproval being represented by a cryptographic digital asset governed by a smart contract on a blockchain, wherein the cryptographic digital asset comprises a non-fungible token (NFT), and where the first buyer's guaranteed mortgage preapproval NFT storing first buyer information, property information, and seller information;
receiving, at the computing device, a request from the first buyer to prepare a contract record for storing contract data regarding terms of the contract in a blockchain or a database; and
linking the guaranteed mortgage preapproval NFT with the contract record for recordation in a new block in the blockchain distributed ledger.

8. The non-transitory computer readable storage media of claim 7, wherein the request to prepare the contract record is associated with an offer to buy real property backed by the guaranteed mortgage preapproval, wherein the offer has been accepted by a seller of the real property.

9. The non-transitory computer readable storage media of claim 8, wherein the contract is a smart contract that includes computer-readable instructions for verifying, authenticating and approving the property transfer-related event according to the terms and conditions of a buy-sell agreement of the offer.

10. The method of non-transitory computer readable storage media of claim 9, further comprising linking the second buyer's guaranteed mortgage preapproval NFT with the contract record for recordation in a new block in the blockchain distributed ledger.

11. The method of claim 9, wherein the second buyer's guaranteed mortgage preapproval NFT is issued by the lender upon receiving, at the computing device, a request from the second buyer for the guaranteed mortgage preapproval terms by the lender; and is governed by the smart contract on the blockchain.

12. A system comprising:
a processor configured for:
receiving, at a computing device, a request from a first buyer for a guaranteed mortgage preapproval terms by a lender;
in response to receiving the request, transmitting, by the computing device, a user interface to a computing device of the first buyer over at least one network to allow the first buyer to enter into the user interface data relevant to obtaining a guaranteed mortgage preapproval;
receiving the data, at the computing device over the at least one network from the computer of the first buyer via the user interface, in response to the first buyer entering in the data into the user interface, wherein the received data comprises borrower information including a home value, a down payment, and a mortgage term;
issuing the guaranteed mortgage preapproval to the first buyer, the guaranteed mortgage preapproval being represented by a cryptographic digital asset governed by a smart contract on a blockchain, wherein the cryptographic digital asset comprises a non-fungible token (NFT), and where the first buyer's guaranteed mortgage preapproval NFT storing first buyer information, property information, and seller information;
receiving, at the computing device, a request from the first buyer to prepare a contract record for storing contract data regarding terms of the contract in a blockchain or a database; and
linking the guaranteed mortgage preapproval NFT with the contract record for recordation in a new block in the blockchain distributed ledger.

13. The system of claim 12, wherein the request to prepare the contract record is associated with an offer to buy real property backed by the guaranteed mortgage preapproval, wherein the offer has been accepted by a seller of the real property.

14. The system of claim 13, wherein the contract is a smart contract that includes computer-readable instructions for verifying, authenticating and approving the property transfer-related event according to the terms and conditions of a buy-sell agreement of the offer.

15. The system of claim 14, further comprising linking the second buyer's guaranteed mortgage preapproval NFT with the contract record for recordation in a new block in the blockchain distributed ledger.

16. The method of claim 14, wherein the second buyer's guaranteed mortgage preapproval NFT is issued by the lender upon receiving, at the computing device, a request from the second buyer for the guaranteed mortgage preapproval terms by the lender; and is governed by the smart contract on the blockchain.
